(19) United States
(12) Patent Application Publication
(10) Pub. No.: US 2007/0046880 A1
(43) Pub. Date: Mar. 1, 2007

(54) Liquid crystal display apparatus and method of producing the same

(75) Inventors: Masanobu Shigeta, Kanagawa-Ken (JP); Tetsuhiro Yamazaki, Kanagawa-Ken (JP); Hiroyuki Natsuhori, Kanagawa-Ken (JP); Masanobu Yoshida, Ibaraki-Ken (JP); Takuya Kakinuma, Kanagawa-Ken (JP)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(73) Assignee: Victor Company of Japan, Ltd. a corporation of Japan, Yokohama-Shi (JP)

(21) Appl. No.: 11/506,070

(22) Filed: Aug. 16, 2006

(30) Foreign Application Priority Data
Aug. 24, 2005 (JP) 2005-242404
Mar. 28, 2006 (JP) 2006-089209
Jul. 31, 2006 (JP) 2006-207488

(51) Int. Cl. G02F 1/1333

(52) U.S. Cl. 349/138; 349/113

(57) ABSTRACT

A liquid crystal display apparatus includes a driver substrate having a pixel area with pixel electrodes and drive circuits each driving the corresponding pixel electrode arranged in a matrix in the pixel area and a transparent substrate having an opposing electrode. The driver substrate and the transparent substrate face each other with a liquid crystal filled between the pixel electrodes and the opposing electrode. A dielectric material is provided in a gap between each pair of two adjacent pixel electrodes, with 0.2 λ or lower (λ being a wavelength of reading light to be used) in phase difference of a step created on the dielectric material provided in the gap with respect to each pixel electrode. A first dielectric film and a second dielectric film are laminated in order in the pixel area. The second dielectric film exhibits a higher refractive index than the first dielectric film.

### CROSS-REFERENCE TO RELATED APPLICATIONS

This application is based on and claims the benefit of priority from the prior Japanese Patent Application Nos. 2005-242404 filed on Aug. 24, 2005, 2006-089209 filed on Mar. 28, 2006, and 2006-207488 filed on Jul. 31, 2006, the entire contents of which are incorporated herein by reference.

### BACKGROUND OF THE INVENTION

The present invention relates to a reflective liquid crystal display apparatus for use in large-screen display apparatuses such as video projectors and a method of producing such a liquid crystal display apparatus.

There is an increased demand for display apparatuses for outdoor public use or airport control, high-definition display apparatuses, such as Hi-Vision, and projection-type display apparatuses such as projectors for projecting images onto a screen.

Projection-type display apparatuses are classified into a transmissive type and a reflective type. Both types employ a liquid crystal display apparatus in which an incident reading light beam is modulated per pixel in accordance with a video signal so that it is turned into a light beam to be projected onto a screen.

Brightness is one of the major factors in deciding display performance of display apparatuses such as projectors. Higher brightness requires higher efficiency for light sources, optical systems, etc., with higher reflectivity for pixel electrodes especially important for reflective liquid crystal display apparatuses when installed in such projectors. Higher aperture is another factor in enhancing brightness.

A smaller gap between adjacent pixels (referred to as an interpixel gap, hereinafter) provides higher aperture due to the fact that the pixel-electrode area decides the aperture in reflective liquid crystal display apparatuses. However, for example, an interpixel gap of 0.3 μm with high yielding requires 0.15 μm (or lower) microfabrication technology. Contrary to this, wafer-based driver circuitry does not require such microfabrication technology. Thus, installation of expensive microfabrication equipment only for pixel fabrication leads to huge cost.

Regarding reflectivity, pixel electrodes generally made of aluminum or an aluminum-alloy film of AlCu, AlSiCu, etc., exhibit reflectivity of about 85 to 89% in liquid crystal, which may not necessarily be sufficient for providing high brightness. An alternative to aluminum alloy may be silver alloy that exhibits a higher reflectivity. Nonetheless, processing of silver alloy is difficult and costly, thus not practical.

A technique to solve such a problem is coating an aluminum-alloy electrode with a silver-alloy film for a higher pixel-electrode reflectivity, for example, disclosed in Japanese Unexamined Patent Publication No. 2004-012670.

Indicated in FIG. 1 is spectral reflectivity for a silver-alloy-coated aluminum-alloy electrode with change in thickness of a silver-alloy film in the range from 0 to 100 nm. Several display apparatuses experimentally produced with such a technique did not show enhancement in brightness in accordance with data indicated in FIG. 1. The inventors of the present invention found that, under this technique, increased are not only pixel-electrode reflectivity but also so loss of brightness due to diffraction.

Another technique to enhance reflectivity is coating a pixel electrode with a reflectivity-enhancing film made of a multilayered dielectric film having a lower-refractive-index film and a higher-refractive-index film at about λ/4 (λ: wavelength) in optical film thickness for each, disclosed, for example, in Japanese Unexamined Patent Publication No. 11(1999)-344726. In principle, such a reflectivity-enhancing film offers a higher reflectivity to pixel electrodes.

These pixel electrodes are generally covered with an insulating material such as SiO₂ so that gaps between adjacent pixels are filled with insulating material for step coverage to avoid low image quality. The insulating material are then selectively etched back to be planarized.

Selective etch back in this process is usually over-etching to eliminate partial variation in thickness of the insulating material of SiO₂ which otherwise be caused by SiO₂ remaining on the top of the pixel electrodes.

The gap between adjacent pixel electrodes is, for example, about 0.5 to 1 μm in liquid crystal display apparatuses. Thus, such over-etching discussed above could cause a step to be created for an insulating material filled between adjacent pixel electrodes, with a height of 50 to 90 nm when viewed from the top of the pixel electrodes.

It is also found by the inventors of the present invention that display apparatuses experimentally produced with a reflectivity-enhancing film mentioned above formed on such a step caused by over-etching exhibited not only a higher reflectivity but also higher refraction which then caused large loss of reflectivity, resulting in reduced brightness.

Although it is not impossible to produce a display apparatus having substantially no steps with precisely controlled processing, it significantly reduces productivity which leads to cost up, thus impractical. Such precisely controlled processing has not conventionally required, with no particular problems.

### SUMMARY OF THE INVENTION

A purpose of the present invention is to provide a liquid crystal display apparatus with almost planar or no steps between adjacent pixels that exhibits a higher reflectivity and a method of producing such a liquid crystal display apparatus without installation of an advanced microfabrication equipment and precisely controlled processing.

The present invention provides a liquid crystal display apparatus comprising: a driver substrate having a pixel area with pixel electrodes and drive circuits each driving the corresponding pixel electrode arranged in a matrix in the pixel area, an dielectric material being provided in a gap between each pair of two adjacent pixel electrodes, with 0.2 λ or lower (λ being a wavelength of reading light to be used) in phase difference of a step created on the dielectric material provided in the gap with respect to each pixel electrode, a first dielectric film and a second dielectric film being laminated in order in the pixel area, the second dielectric film exhibiting a higher refractive index than the first dielectric film; and a transparent substrate having an opposing electrode, the driver substrate and the transparent substrate facing each other with a liquid crystal filled between the pixel electrodes and the opposing electrode.

Moreover, the present invention provides a liquid crystal display apparatus comprising: a driver substrate having pixel electrodes and drive circuits each driving the corresponding pixel electrode arranged in a matrix, a first dielectric film of an dielectric material being provided over the pixel electrodes and in a gap between each pair of two adjacent pixel electrodes, with 0.2 λ or lower (λ being a wavelength of reading light to be used) in phase difference of a step created on the dielectric material provided in the gap with respect to each pixel electrode, a second dielectric film being formed on the first dielectric film, the second dielectric film exhibiting a higher refractive index than the first dielectric film; and a transparent substrate having an opposing electrode, the driver substrate and the transparent substrate facing each other with a liquid crystal filled between the pixel electrodes and the opposing electrode.

Furthermore, the present invention provides a method of producing a liquid crystal display apparatus including a driver substrate having pixel electrodes and drive circuits each driving the corresponding pixel electrode arranged in a matrix and a transparent substrate having an opposing electrode, the driver substrate and the transparent substrate facing each other with a liquid crystal filled between the pixel electrodes and the opposing electrode, the method comprising the steps of: forming a dielectric layer of a dielectric material over the pixel electrodes while filling the dielectric material into a gap between each pair of two adjacent pixel electrodes, with 0.2 λ or lower (λ being a wavelength of reading light to be used) in phase difference of a step created on the dielectric material provided in the gap with respect to each pixel electrode; planarizing a surface of the dielectric layer; etching the planarized dielectric layer until at least the pixel electrodes are exposed at an almost same etching rate to the planarized dielectric layer and the pixel electrodes; forming a first dielectric film over the etched dielectric layer and pixel electrodes; and forming a second dielectric film on the first dielectric film, the second dielectric film exhibiting a higher refractive index than the first dielectric film.

Still furthermore, the present invention provides a method of producing a liquid crystal display apparatus including a driver substrate having pixel electrodes and drive circuits each driving the corresponding pixel electrode arranged in a matrix and a transparent substrate having an opposing electrode, the driver substrate and the transparent substrate facing each other with a liquid crystal filled between the pixel electrodes and the opposing electrode, the method comprising the steps of: forming a dielectric layer of a dielectric material over the pixel electrodes while filling the dielectric material into a gap between each pair of two adjacent pixel electrodes, with 0.2 λ or lower (λ being a wavelength of reading light to be used) in phase difference of a step created on the dielectric material provided in the gap with respect to each pixel electrode; planarizing a surface of the dielectric layer so that the dielectric layer is turned into a first dielectric film; and forming a second dielectric film on the first dielectric film, the second dielectric film exhibiting a higher refractive index than the first dielectric film.

Moreover, the present invention provides a method of producing a liquid crystal display apparatus including a driver substrate having pixel electrodes and drive circuits each driving the corresponding pixel electrode arranged in a matrix and a transparent substrate having an opposing electrode, the driver substrate and the transparent substrate facing each other with a liquid crystal filled between the pixel electrodes and the opposing electrode, the method comprising the steps of: forming a dielectric layer of a dielectric material over the pixel electrodes while filling the dielectric material into a gap between each pair of two adjacent pixel electrodes, with 0.2 λ or lower (λ being a wavelength of reading light to be used) in phase difference of a step created on the dielectric material provided in the gap with respect to each pixel electrode; planarizing a surface of the dielectric layer; etching the planarized dielectric layer until at least the pixel electrodes are exposed; etching the exposed pixel electrodes only; forming a first dielectric film over the etched dielectric layer and pixel electrodes; and forming a second dielectric film on the first dielectric film, the second dielectric film exhibiting a higher refractive index than the first dielectric film.

Still furthermore, the present invention provides a method of producing a liquid crystal display apparatus including a driver substrate having pixel electrodes and drive circuits each driving the corresponding pixel electrode arranged in a matrix and a transparent substrate having an opposing electrode, the driver substrate and the transparent substrate facing each other with a liquid crystal filled between the pixel electrodes and the opposing electrode, the method comprising the steps of: forming a cover layer on the pixel electrodes; forming a dielectric layer of a dielectric material over the pixel electrodes via the cover layer while filling the dielectric material into a gap between each pair of two adjacent pixel electrodes, with 0.2 λ or lower (λ being a wavelength of reading light to be used) in phase difference of a step created on the dielectric material provided in the gap with respect to each pixel electrode; planarizing a surface of the dielectric layer; etching the dielectric layer until the cover layer is exposed; etching the exposed cover layer only to expose the pixel electrodes; forming a first dielectric film over the etched dielectric layer and the exposed pixel electrodes; and forming a second dielectric film on the first dielectric film, the second dielectric film exhibiting a higher refractive index than the first dielectric film.

### BRIEF DESCRIPTION OF DRAWINGS

FIG. 1 is a view indicating enhanced reflectivity using a silver alloy film;

FIG. 2 is a view indicating simulated results of zero-order reflectivity;

FIG. 3 is a view illustrating a basic structure of a projector equipped with a liquid crystal display apparatus;

FIG. 4 is a view showing an equivalent circuit of each of multiple pixels;

FIG. 5 is a partially-enlarged cross section of major components of a liquid crystal display apparatus;

FIG. 6 is an enlarged view illustrating a portion of a pixel electrode of a liquid crystal display apparatus;

FIG. 7 is a view illustrating a process of filling the gap between adjacent pixels with an insulating material;

FIG. 8 is an enlarged view illustrating a portion of multiple pixel electrodes of a liquid crystal display apparatus, as a first apparatus embodiment according to the present invention;

FIG. 9 is an enlarged view illustrating a portion of multiple pixel electrodes of a liquid crystal display apparatus, as a second apparatus embodiment according to the present invention;

FIG. 10 is a view illustrating a process of producing a major section of a liquid crystal display apparatus, as a first method embodiment according to the present invention;

FIG. 11 is a view illustrating a process of producing a major section of a liquid crystal display apparatus, as a second method embodiment according to the present invention;

FIG. 12 is a view illustrating a process of producing a major section of a liquid crystal display apparatus, as a first modification to the second method embodiment according to the present invention;

FIG. 13 is a view illustrating a process of producing a major section of a liquid crystal display apparatus, as a second modification to the second method embodiment according to the present invention;

FIG. 14 is a view illustrating a process of producing a major section of a liquid crystal display apparatus, as a third method embodiment according to the present invention;

FIG. 15 is a view illustrating, in detail, the process of producing a major section of a liquid crystal display apparatus, shown in FIG. 14, as the third embodiment according to the present invention;

FIG. 16 is a view illustrating a process of producing a major section of a liquid crystal display apparatus, as a modification to the third method embodiment according to the present invention;

FIG. 17 is a view illustrating, in detail, the process of producing a major section of a liquid crystal display apparatus, shown in FIG. 16, as the modification to the third method embodiment according to the present invention; and

FIG. 18 is view showing an optical system to be used for evaluating a liquid crystal display apparatus.

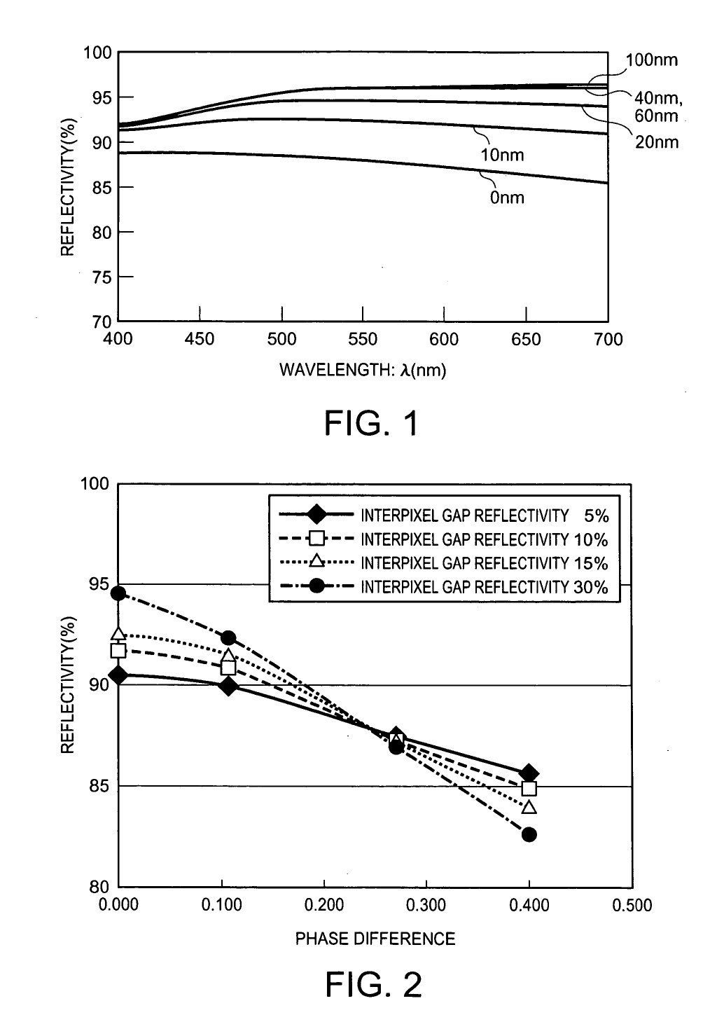

### DETAILED DESCRIPTION OF PREFERRED EMBODIMENTS

The inventors of the present invention devoted themselves to study reflectivity enhancements with a reflectivity-enhancing film and experimentally found that a reflectivity-enhancing film principally gives a higher reflectivity to a pixel electrode but not always for display apparatuses with several ten μm or lower in pixel pitch produced with microfabrication technology.

The reasons are: a display apparatus having pixel electrodes arranged at a certain interpixel gap (a gap between adjacent electrodes) suffers diffracted light beams with considerable amounts; and the strength of diffraction depends on reflectivity and phase difference at pixel electrodes and gaps therebetween.

There would be no phase differences if pixel electrodes and their gaps were completely planar. However, each gap between adjacent pixel electrodes always has a step due to the manner of processing. It is also found that a reflectivity-enhancing film inevitably formed on the gap causes higher diffraction.

FIG. 2 shows simulated results of change in the loss of reflectivity due to diffraction generated on steps created in pixel gaps. In detail, FIG. 2 shows zero-order reflectivity versus phase difference due to steps with reflectivity on pixel gaps as a parameter, at 9.5 μm in pixel pitch and 0.63 μm in interpixel gap. The zero-order reflectivity is defined as 100% when the reflectivity is 100% on interpixel gaps with no steps (0 in phase difference).

FIG. 2 teaches the following: the total reflectivity would naturally increase as proportional to the amount by which the reflectivity on interpixel gaps increases if the phase difference were zero; whereas as the phase difference becomes larger, for example, 0.25λ or larger, the total reflectivity is lowered than 87% (the level directly decided by aperture) even when the reflectivity on interpixel gaps is 30% (the largest among the four parameters in FIG. 2).

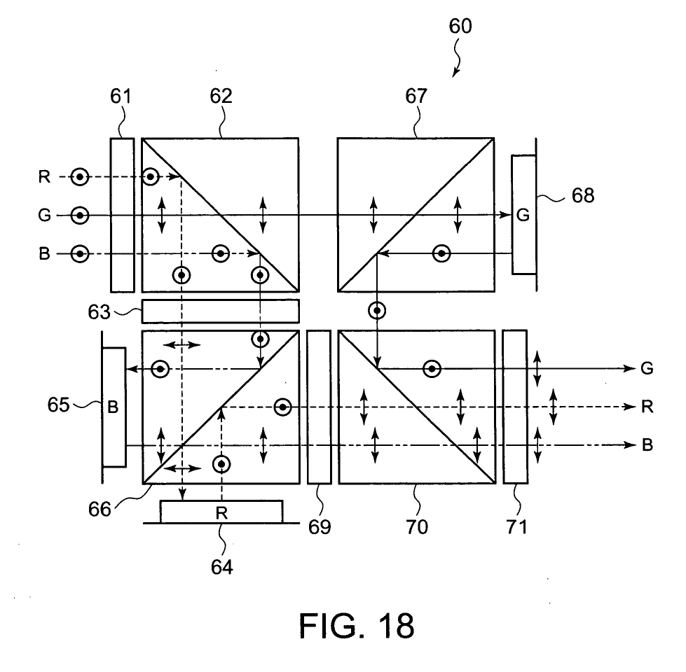

When a display apparatus having such reflectivity characteristics is used for an optical system shown in FIG. 18 and described later, a long optical length to a projection lens obstructs usage of higher-order diffracted light and thus restricts reflected light to be projected onto a screen, resulting in lower brightness.

In production of a display apparatus, pixel electrodes are patterned on a driver substrate (for accommodating driver circuitry), inevitably with a step of about 200 to 300 nm from the substrate between adjacent pixel electrodes. A larger step could create larger misalignment to lower image quality for a display apparatus having an alignment film over the pixel electrodes.

Generally, interpixel gaps (in which a step is inevitably created) are filled with an insulating (dielectric) material such as SiO₂, followed by a planarizing procedure to prevent image quality from being lowered. To enhance reflectivity, a dielectric film is applied after the planarizing procedure to have a reflectivity-enhancing structure, as disclosed, for example, in WO 00/38223 (TOKU-HYOU 2002-533773).

A planar surface actually inevitably has small steps or undulation. In LSI processing, over-etching is performed for higher yielding which inevitably creates a step on an insulating material filled between adjacent pixels when viewed from the top of pixel electrodes.

Undulation also occurs on an insulating material such as SiO₂ formed by CVD (Chemical Vapor Deposition) at a thickness to completely fill interpixel gaps. Such undulation somewhat remains even is by CMP (Chemical Mechanical Polishing), so that a desired planar surface cannot be achieved. A substantially thick planarizing film offers a more planar surface with polishing. Such a substantially thick planarizing film, however, requires a longer polishing time and suffers variation in film thickness, thus requiring more over-etching.

Figures with ideally planar surfaces shown, for example, in WO 00/38223 do not indicate completely planar surfaces. Planarization is performed to eliminate misalignment for higher image quality. This purpose can be achieved even if there is some irregularity. In other words, a surface having some irregularity but fulfilling such purpose can be treated as a substantially planar surfaces.

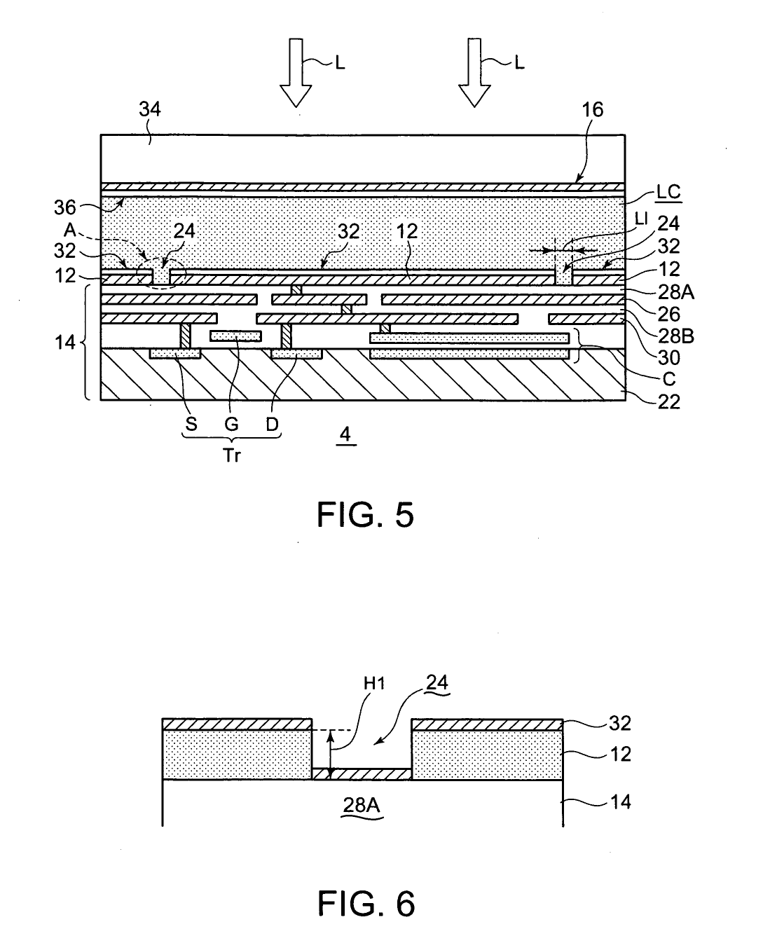

FIG. 5 in WO 00/38223 clearly shows the difference from the present invention in that the structure shown in this figure exhibits higher pixel reflectivity to offer higher image quality whereas could give adverse effects to brightness when installed in a projector.

The inventors of the present invention reached the invention based on the findings discussed above.

Disclosed below in detail are several embodiments and modifications for a liquid crystal display apparatus and a method of producing the same according to the present invention.

The same reference signs and numerals are used for the same or analogous components through the drawings in the following disclosure.

Described first is a projector, an exemplary application of a liquid crystal display apparatus according to the present invention.

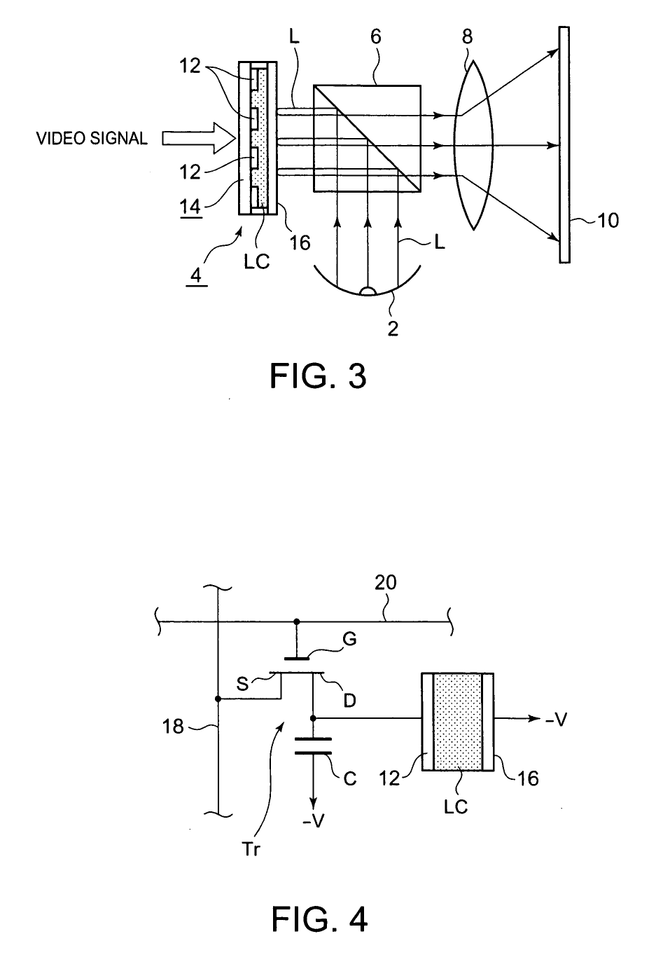

As illustrated in FIG. 3, the projector is equipped with: a light source 2 for emitting reading light L; a liquid crystal display apparatus 4 having a liquid crystal LC filled therein for modulating the light L in accordance with a video signal, the modulated light L being reflected therefrom; a polarization beam splitter 6 for polarizing the light L emitted from the light source 2 and directing the polarized light L to the display apparatus 4 while allowing the light L reflected from the display apparatus 4 therethrough; and a projection lens 8 for projecting the light L passing through the beam splitter 6 to a screen 10, thus an image carried by the video signal being displayed on the screen 10.

The liquid crystal display apparatus 4 consists of a driver substrate 14 having reflective pixel electrodes (reflective electrodes) 12 arranged thereon in a matrix and a transparent opposing electrode 16 shared by the electrodes 12, with the liquid crystal LC filled therebetween. Multiple pixels are arranged on the substrate 14 in vertical and horizontal directions in a matrix. The pixel electrodes 12 are arranged in the vertical and horizontal directions to constitute the matrix with a given interpixel gap (a gap between adjacent pixels).

Shown in FIG. 4 is an equivalent circuit of each pixel having a switching transistor Tr, for example, a MOS transistor, and a capacitor C connected to a drain D of the transistor Tr, the drain D being connected to the corresponding pixel electrode 12. A source S of the transistor Tr is connected to a signal line 18 that carries a video signal. A gate G of the transistor Tr is connected to a gage line 20.

Each pixel is cyclically selected by turning on the gate G of the transistor Tr through the gage line 20 while the video signal is being applied to the signal line 18, thus the video signal being stored in the capacitor C. The charges stored in the capacitor C are supplied to the corresponding pixel electrode 12 for a given period even when the gate G is turned off, to drive the liquid crystal LC of each pixel.

Described next with reference to FIG. 5 is the structure of the liquid crystal display apparatus 4 in its cross section.

As described above, the liquid crystal display apparatus 4 consists of the driver substrate 14 and the opposing electrode 16, with the liquid crystal LC filled therebetween.

In detail, the driver substrate 14 has a semiconductor substrate 22, for example, a P-type silicon substrate. Formed on the substrate 22 are each switching transistor Tr having the source S, drain D and gate G, and the corresponding capacitor C adjacent to the transistor Tr, to constitute a driver circuit for driving the corresponding pixel electrode 12.

Arranged in a matrix on the driver substrate 14 are the pixel electrodes 12, with a small gap 24 between adjacent two electrodes 12 so that the two electrodes 12 are isolated from each other. The gap 24 is defined as an interpixel gap that is a gap between adjacent two electrodes 12.

Provided down below each pixel electrode 12 is a light shielding layer 26 via an insulating layer 28A made of, for example, SiO₂. The light shielding layer 26 is provided for blocking light incident toward the semiconductor substrate 22 through the gap 24. The shielding layer 26 is made of aluminum or aluminum alloy so that it also functions as a wiring layer.

Provided below the light shielding layer 26 via an insulating layer 28B made of, for example, SiO₂ is a wiring layer 30 that is divided into several layer portions, one being connected to the source S of the transistor Tr as the signal line 18 (FIG. 4), other being used as connecting the drain D of the transistor Tr to the capacitor C and also to the corresponding pixel electrode 12 via the light shielding layer 26. Formed on each pixel electrode 12 is an alignment film 32.

Formed on a transparent substrate 34 made of a transparent glass plate is the above-mentioned opposing electrode 16 having another alignment film 36 formed thereon (on the lower side of the electrode 16 in FIG. 5).

Filled in the space between the driver substrate 14 having the pixel electrodes 12 and the transparent substrate 34 having the opposing electrode 16 via a spacer (not shown) is the above-mentioned liquid crystal LC, thus constituting the liquid crystal display apparatus.

This liquid crystal display apparatus is a reflective type because it has the driver circuitry with the switching transistor Tr, capacitor C, etc., down below the corresponding pixel electrode 12.

A reflective liquid crystal display apparatus has a higher aperture ratio (the ratio of pixel area serving for light modulation to the total display area) than a transmissive liquid crystal display apparatus. The smaller the pixel size, the higher the aperture ratio.

Nevertheless, the reflective liquid crystal display apparatus has the gap 24 between adjacent two pixel electrodes, as shown in FIG. 5 so that there is no way to achieve 1000% in aperture ratio. The width L1 of the gap 24 is usually in the range from 0.5 to 1 μm. A pixel pitch of about 10 μm with the width L1 in this range gives an aperture ratio of 81 to 90% in mere calculation.

The following planarizing procedure is then performed for higher image quality.

As illustrated in FIG. 6, the pixel electrodes 12 formed by patterning, thus having a step with a level H1 in the range from 200 to 300 nm in each gap 24. A larger step could create larger misalignment to lower image quality for the liquid crystal display apparatus having the alignment film 32 over the pixel electrodes 12.

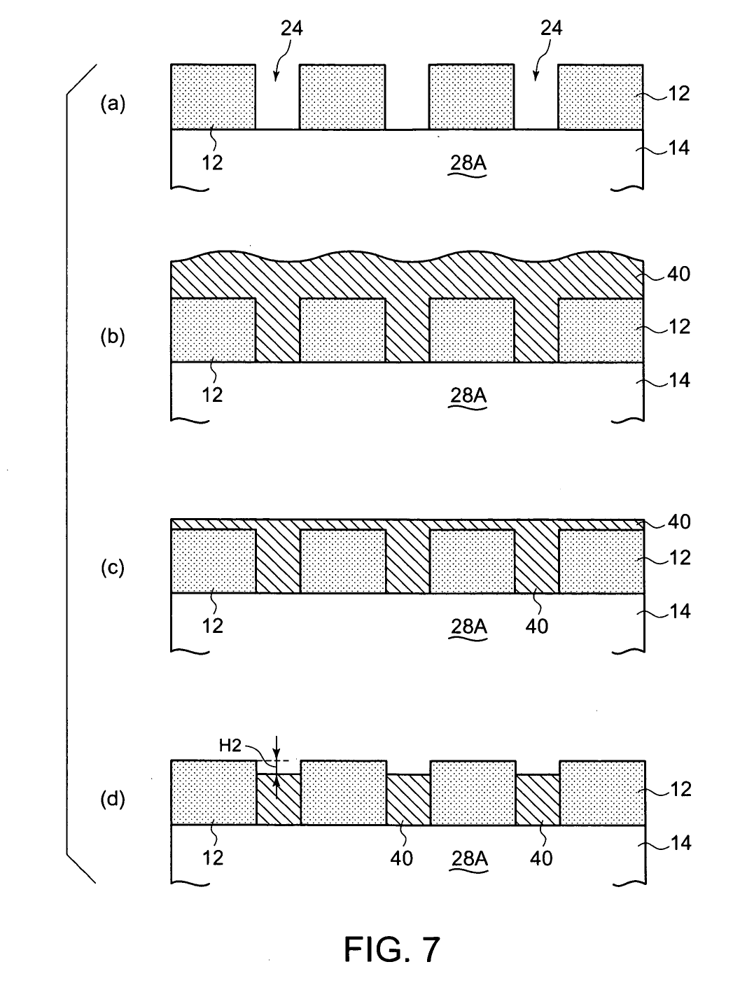

The gaps 24 in which a step is inevitably created are then filled with an insulating material 40 such as SiO₂, followed by a planarizing procedure, to prevent image quality from being lowered, as shown in FIG. 7, which is a known technique in LSI procedure.

In detail, the pixel electrodes 12 are patterned into a matrix over the driver substrate 14, as shown in (a) in FIG. 7. An insulating material 40 made of, for example, SiO₂, is then formed over the pixel electrodes 12 to completely cover the gaps 24, as shown in (b) in FIG. 7, for example, by CVD (Chemical Vapor Deposition).

The insulating material 40 is polished by CMP (Chemical Mechanical Polishing), as shown in (c) in FIG. 7, to an appropriate thickness with a planar surface.

The insulating material 40 is selectively etched back with an etching gas, etc., so that an SiO₂ film of the material 40 remaining on the pixel electrodes 12 after CMP is removed, as shown in (d) in FIG. 7, followed by formation of a reflectivity-enhancing film, if necessarily, and the alignment film 32 at the last stage (not shown).

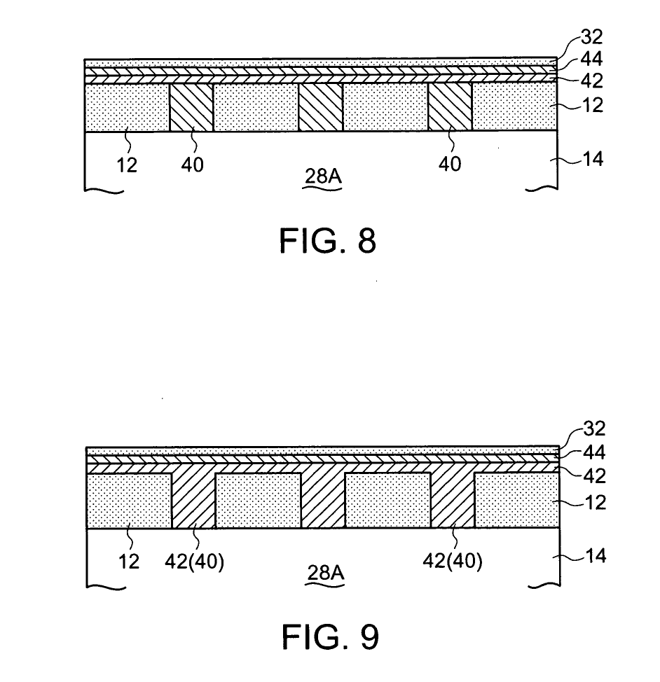

Disclosed next with reference to FIGS. 8 and 9 are a first and a second embodiment, respectively, of a liquid crystal display apparatus according to the present invention.

In the first embodiment of a liquid crystal display apparatus according to the present invention, as shown in FIG. 8, the gaps 24 (FIG. 7) between adjacent square pixel electrodes 12 formed on the insulating layer 28A of the driver substrate 14 are filled with the insulating material 40. The upper surfaces of the gaps 24 and the pixel electrodes 12 are then planarized.

A first planar dielectric film 42 is formed over the planarized surfaces, followed by a second dielectric film 44 thereon. The alignment film 32 is then formed on the second dielectric film 44.

The first dielectric film 42 is made of a material that exhibits a lower refractive index, such as, a silicon oxide film (SiO₂). In contrast, the second dielectric film 44 is made of a material that exhibits a higher refractive index than the first dielectric film 42, such as, a tantalum oxide film (Ta₂O₂). The thickness of each of the films 42 and 44 is adjusted to about ¼ (=λ/4) of a wavelength A to be used, aiming for higher reflectivity enhancing effects.

Selective etching is performed in the first embodiment with an etching ratio of the pixel electrodes 12 to the insulating material 40 at almost 1:1, as discussed below, to achieve an almost same surface level for the pixel electrodes 12 and the insulating material 40 filled in the gaps 24. Therefore, the insulating material 40 and the first dielectric film 42 may be of the same material, as discussed below.

The second embodiment shown in FIG. 9 has the same overall structure as the first embodiment disclosed above, except for: one process (as discussed below) for filling the gaps 24 with the insulating material 40 and forming the first dielectric film 42, with the same material, such as, a silicon oxide film, for the material 40 and the film 42; and etching to planarize the resultant irregular surface of the film 42 to a certain thickness.

As disclosed, the first and second embodiments of a liquid crystal display apparatus according to the present invention are provided with: the first planar dielectric film 42 formed over the planarized surfaces of the pixel electrodes 12 and the gaps 24; and the second dielectric film 44 formed on the first film 42, both at about λ/4 in thickness, with the materials to give a higher refractive index to the second film 44 than the first film 42.

Therefore, the first and second embodiments of a liquid crystal display apparatus according to the present invention exhibit higher reflectivity enhancing effects by means of the lower- and higher-refractive-index dielectric films with overall planar surfaces having almost no steps in the pixel gaps, with no necessity of installation of advanced microfabrication equipment and strict process control.

### First Embodiment of Production Method

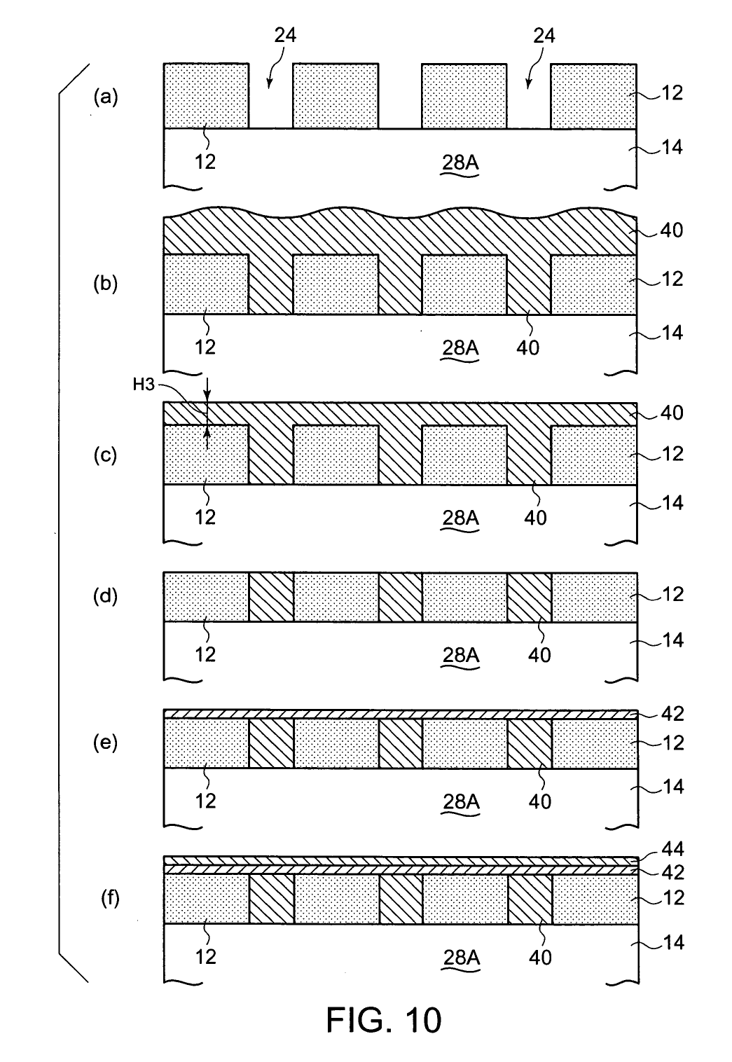

Disclosed next with reference to FIG. 10 is a method (a first method embodiment) of producing major components of the first embodiment of a liquid crystal display apparatus according to the present invention.

The pixel electrodes 12 are patterned into a matrix over the driver substrate 14 with the gaps 24, as shown in (a) in FIG. 10.

The insulating material 40, such as SiO₂, is applied, by for example CVD, over the pixel electrodes 12 so that the gaps 24 are completely filled with the material 40 and an insulating layer 40 is formed over the pixel electrodes 12, with irregular surfaces corresponding to the electrodes 12, as shown in (b) in FIG. 10.

The insulating layer of the insulating material 40 is polished by CMP to an appropriately lower level H3, at which the pixel electrodes 12 are not exposed to, with a planar surface with no irregularities corresponding to the electrodes 12, as shown in (c) in FIG. 10. The level H3 is preferably about 100 nm. A level over the level H3 could suffer a longer etching time after this step.

After the planarizing step in (c) in FIG. 10, the insulating material 40 is etched back so that at least the upper surface of each pixel electrode 12 is exposed, as shown in (d) in FIG. 10. The etching step is performed at the same etching rate to the electrodes 12 and the material 40, with an etching ratio of the electrodes 12 to the material 40 at almost 1:1.

The etching continues for a certain period, after the upper surface of each pixel electrode 12 is exposed, at the same etching rate to the electrodes 12 and the insulating material 40. At the same etching rate, the electrodes 12 and the material 40 are simultaneously etched while keeping planar surfaces even after the electrode surface is exposed, thus the electrode upper surface being lowered a little bit.

The above etching requirement is met, for example, by using Ar+H₂ as an etching gas with appropriate adjustments to plasma power, angle of incidence, etc.

After completion of the etching step, the first dielectric film 42 is formed with a lower-refraction-index material at a certain thickness by deposition over the pixel electrodes 12 and the gaps 24, as shown in (e) in FIG. 10.

Next, as shown in (f) in FIG. 10, the second dielectric film 44 is formed at a certain thickness by deposition with a material that exhibits a higher refraction index than the first dielectric film 42.

For example, the first dielectric film 42 is a 90-nm-thick silicon oxide film whereas the second dielectric film 44 is a 60-nm-thick tantalum oxide film, for offering reflectivity enhancing effects.

Although not shown in FIG. 10, the alignment film 32 is formed on the second dielectric film 44, as shown in FIG. 8.

### Second Embodiment of Production Method

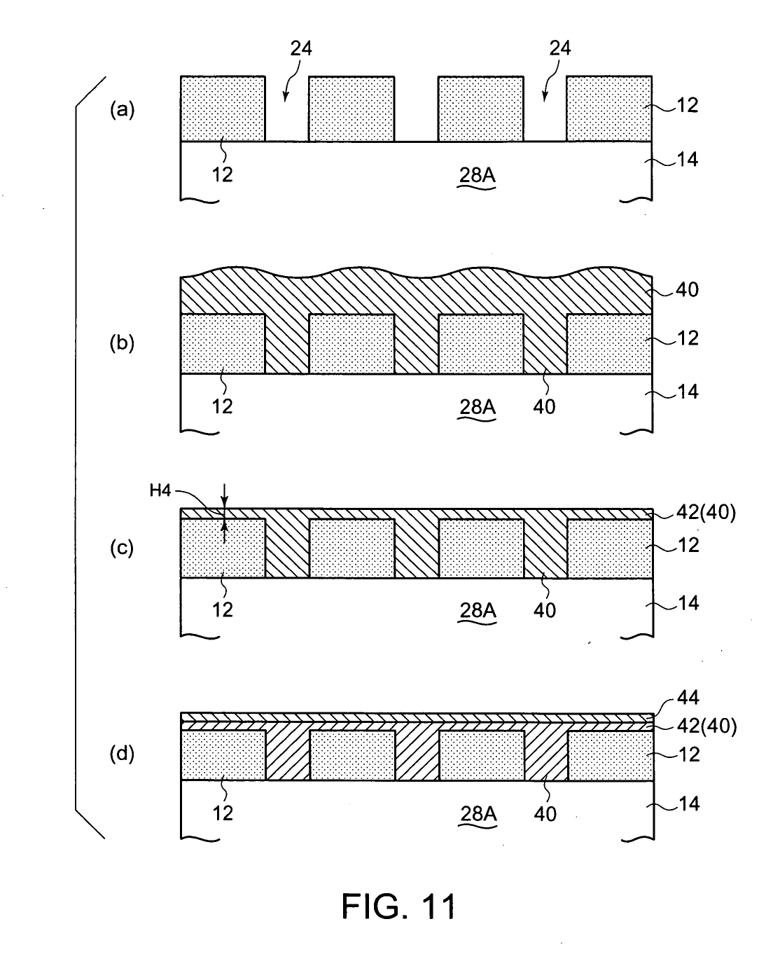

Disclosed next with reference to FIG. 11 is a method (a second method embodiment) of producing major components of the second embodiment of a liquid crystal display apparatus according to the present invention.

Steps illustrated in (a) to (c) in FIG. 11 are identical or analogous to those in (a) to (c) in FIG. 10, respectively, and hence the description of each step is omitted.

Nevertheless, in (c) in FIG. 11, the material to be used for the insulating material 40 is the same as the first dielectric film 42. Moreover, in (c) in FIG. 11, the insulating material 40 is polished by CMP to a level lower than in (c) in FIG. 10. Major requirements in this step are that the first dielectric film 42 be formed with a smaller film-thickness distribution and polished with a smaller undulation on its surface.

In detail, in (c) in FIG. 11, the surface of the insulating material 40 is polished and planarized by CMP to a thickness level H4 lower than H3 in (c) in FIG. 10, to have the first planar dielectric film 42. The level H4 (the thickness of the film 42) is, for example, 90 nm the same as shown in FIG. 10.

Next, as shown in (d) in FIG. 11, the second dielectric film 44 is formed on the first dielectric film 42 at a certain thickness by deposition with a material that exhibits a higher refraction index than the first film 42. The second dielectric film 44 is, for example, a 60-nm-thick tantalum oxide film. The combination of the first and second dielectric film 42 and 44 offers reflectivity enhancing effects.

Although not shown in FIG. 11, the alignment film 32 is formed on the second dielectric film 44, as shown in FIG. 9.

[First Modification to Second Embodiment of Production Method]

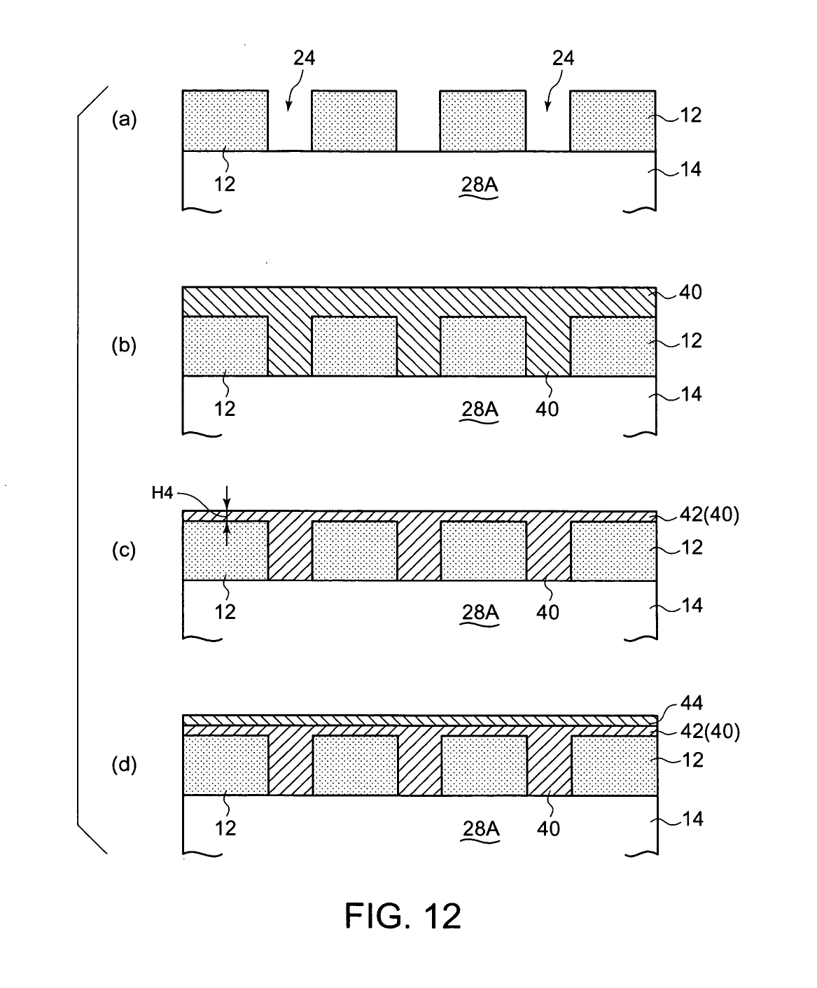

Disclosed next with reference to FIG. 12 is a first modification to the second method embodiment of producing major components of a liquid crystal display apparatus according to the present invention.

A step illustrated in (a) in FIG. 12 is identical to that in (a) in FIG. 11, and hence the description of the step is omitted.

In (b) in FIG. 12, the insulating material 40 is formed with an SOG (Spin-On-Grass) material, which exhibits low viscosity to be easily planarized even if it is thin, such as, CERAMATE LNT available from Catalysts & Chemicals Industries Co., Ltd. It is formed at 150 nm in thickness on the pixel electrodes 12.

The insulating material 40 is then etched by RIE (Reactive Ion Etching) to provide the first dielectric film 42 having a thickness level H4, as shown in (c) in FIG. 12. The level H4 is, for example, 90 nm the same as shown in FIG. 10.

Next, as shown in (d) in FIG. 12, the second dielectric film 44 of Ta₂O₂ is formed by deposition at a thickness of 60 nm. The combination of the first and second dielectric film 42 and 44 offers reflectivity enhancing effects.

[Second Modification to Second Embodiment of Production Method]

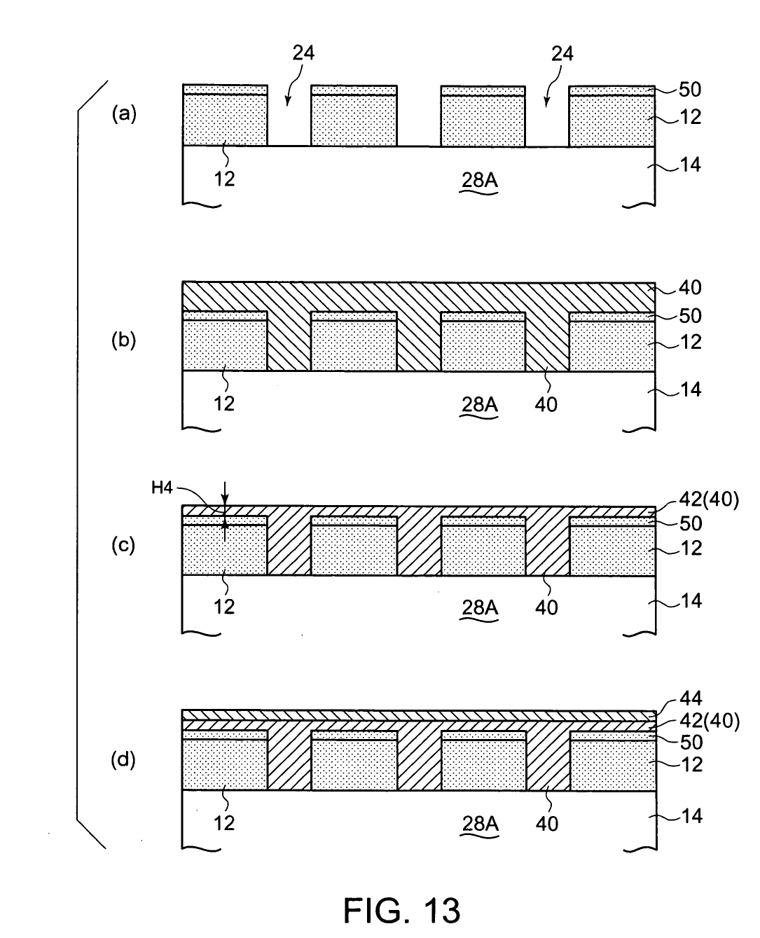

Disclosed next with reference to FIG. 13 is a second modification to the second method embodiment of producing major components of a liquid crystal display apparatus according to the present invention.

In (a) in FIG. 13, the pixel electrodes 12 are patterned over the driver substrate 14 after a 30-nm-thick silver alloy film 50 is formed on aluminum alloy electrodes.

The succeeding steps are analogous to those in the first modification disclosed above. In other words, steps illustrated in (b) to (d) in FIG. 13 are identical or analogous to those in (b) to (d) in FIG. 12, respectively, and hence the description of each step is omitted.

### Third Embodiment of Production Method

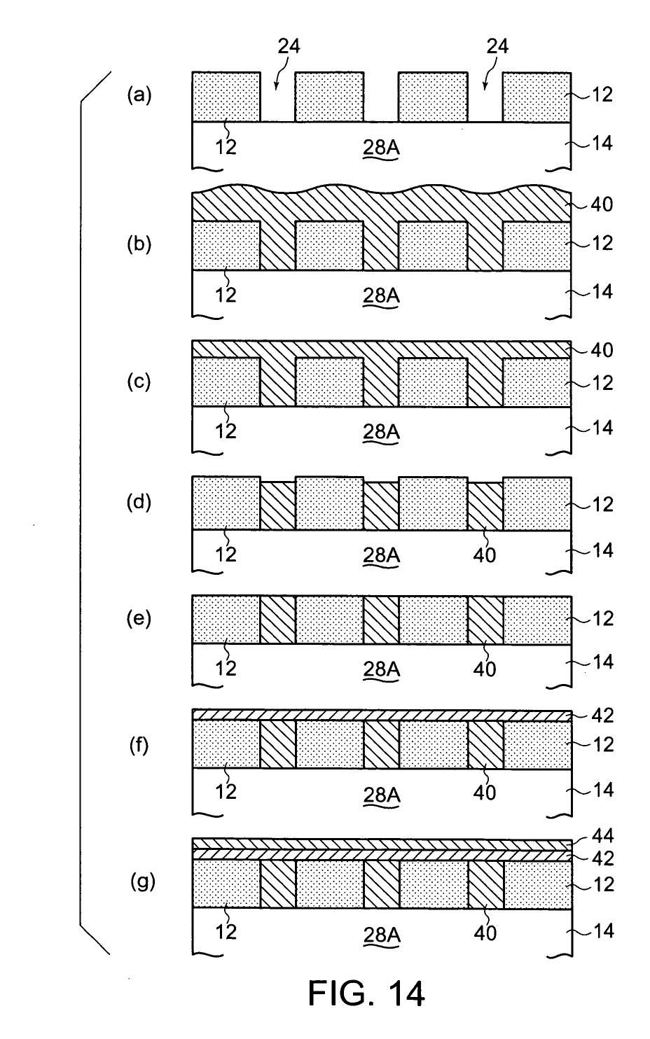

Disclosed next with reference to FIG. 14 is a third method embodiment of producing major components of a liquid crystal display apparatus according to the present invention.

Steps illustrated in (a) to (c) in FIG. 14 are identical or analogous to those in (a) to (c) in FIG. 10, respectively, and hence the description of each step is omitted.

After completion of the CMP planarization step in (c) in FIG. 14, an insulating layer of the insulating material 40 is etched back until at least the upper surface of each pixel electrode 12 is exposed, as shown in (d) in FIG. 14.

The etching continues for a certain period after the upper surface of each pixel electrode 12 is exposed. Difference in etching rate between the pixel electrode 12 and the insulating material 40 causes that the insulating material 40 is more etched than the pixel electrode 12, resulting in a step being created therebetween.

An etching rate for the insulating material 40 is higher in the early stage of etching and that causes creation of a larger step. However, the etching rate is lowered as the insulating material 40 is etched more because it becomes harder for an etching gas to flow into the etched concave sections. And, almost no sections of the material 40 are etched in the final stage of etching,

Therefore, a longer etching time provides more uniform steps over the substrate even if the substrate exhibits a larger film-thickness distribution.

Next, as shown in (e) in FIG. 14, the pixel electrodes 12 are only etched and planarized by RIE to remove the steps between the electrodes 12 and the insulating material 40.

The above etching requirement is met, for example, by using gaseous chlorine, such as Cl₂, as an etching gas.

After completion of the etching step, the first dielectric film 42 is formed with a lower-refraction-index material at a certain thickness by deposition, as shown in (f) in FIG. 14.

Next, as shown in (g) in FIG. 14, the second dielectric film 44 is formed at a certain thickness by deposition with a material that exhibits a higher refraction index than the first dielectric film 42.

For example, the first dielectric film 42 is a 90-nm-thick silicon oxide film whereas the second dielectric film 44 is a 60-nm-thick tantalum oxide film, for offering reflectivity enhancing effects.

Although not shown in FIG. 14, the alignment film 32 is formed on the second dielectric film 44, as shown in FIG. 8.

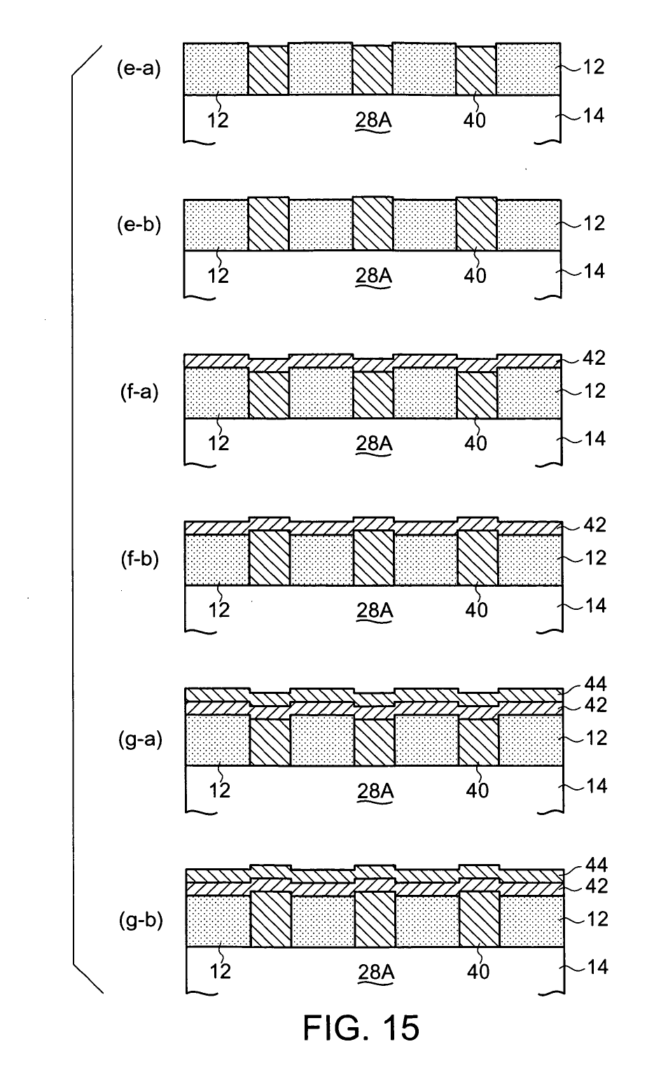

The steps illustrated in (e) to (g) in FIG. 14 according to the third method embodiment are described far more in detail with reference to FIG. 15.

The etching step in (e) in FIG. 14 to etch only the pixel electrodes 12 corresponds to a step illustrated in (e-a) or (e-b) in FIG. 15 to etch and planarize only the pixel electrodes 12 by RIE to remove the steps between the electrodes 12 and the insulating material 40.

This etching step is relatively easy because a step height is mere 80 nm or so. However, even under the best etching requirements, variation in step height, etching rate, etc., still allows a small step to remain, such as, concave sections on the upper surfaces of the material 40 with respect to those of the electrodes 12 as shown in (e-a) in FIG. 15 or convex sections on the material 40 to the electrodes 12 as shown in (e-b) in FIG. 15. These steps, however, exhibit a phase difference of 0.2 λ or smaller due to etching only to the electrodes 12, thus not restricting reflectivity enhancing effects.

After completion of the etching step, the first dielectric film 42 is formed with a lower-refraction-index material at a certain thickness by deposition, as shown in (f-a) or (f-b) in FIG. 15. Illustrated in (f-a) and (f-b) in FIG. 15 are the first dielectric film 42 formed with respect to the concave sections and the convex sections, respectively, created on the upper surfaces of the material 40 in the etching step.

Next, as shown in (g-a) or (g-b) in FIG. 15, the second dielectric film 44 is formed at a certain thickness by deposition with a material that exhibits a higher refraction index than the first dielectric film 42. Illustrated in (g-a) and (g-b) in FIG. 15 are the second dielectric film 44 formed with respect to the concave sections and the convex sections, respectively, created on the upper surfaces of the material 40 in the etching step discussed above.

[Modification to Third Embodiment of Production Method]

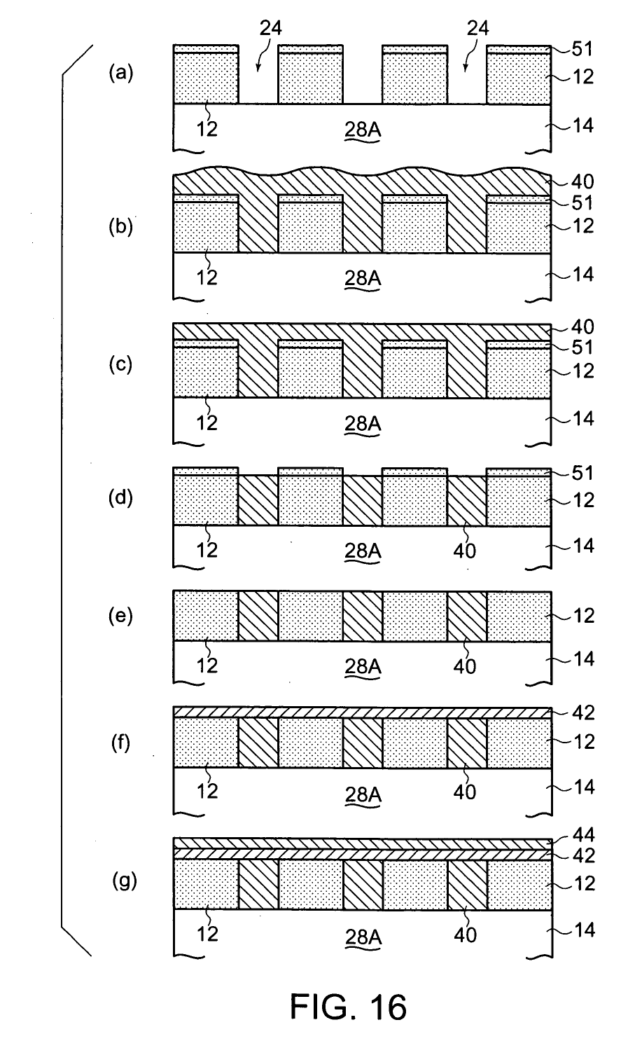

Disclosed next with reference to FIG. 16 is a modification to the third method embodiment of producing major components of a liquid crystal display apparatus according to the present invention.

The modification shown in FIG. 16 is a modified version of the third method embodiment shown in FIG. 14, with an additional step to form a cover layer 51 over the pixel electrodes 12 for smaller steps or undulation as much as possible inevitably created on the etched surface in the step in (e) in FIG. 14.

In the additional step in (a) in FIG. 16, a conductive film (for the pixel electrodes 12) is formed on the driver substrate 14. The cover layer 51 that is a metal nitride film, such as a TiN film, is formed on the conductive film at a certain thickness. An electrode processing step is then performed with photolithography to form the pixel electrodes 12 in a matrix.

Although the cover layer 51 is indicated, steps illustrated in (b) to (d) in FIG. 16 are substantially identical to those in (b) to (d) in FIG. 14, respectively, and hence the description of each step is omitted.

Nevertheless, in the etching step in (d) in FIG. 16, an insulating layer of the insulating material 40 is etched back until at least the upper surface of the cover layer 51 formed on the pixel electrodes 12 is exposed.

Next, as shown in (e) in FIG. 16, the cover layer 51 formed on the pixel electrodes 12 is only etched by RIE.

The above etching requirement is met, for example, by using gaseous chlorine, such as Cl₂, as an etching gas.

A TiN film can be etched several times faster than the pixel electrodes 12, when used as the cover layer 51. In other words, an etching rate for the TiN film is several times faster than the pixel electrodes 12. The cover layer 51 is thus removed almost completely while almost no portion of the the pixel electrodes 12 is being etch away. Accordingly, a TiN film formed at a thickness corresponding to the step height indicated in (d) in FIG. 14 offers the planer surface shown in (e) in FIG. 16.

The succeeding steps illustrated in (f) and (g) in FIG. 16 are identical or analogous to those in (f) and (g) in FIG. 14, respectively, and hence the description of each step is omitted.

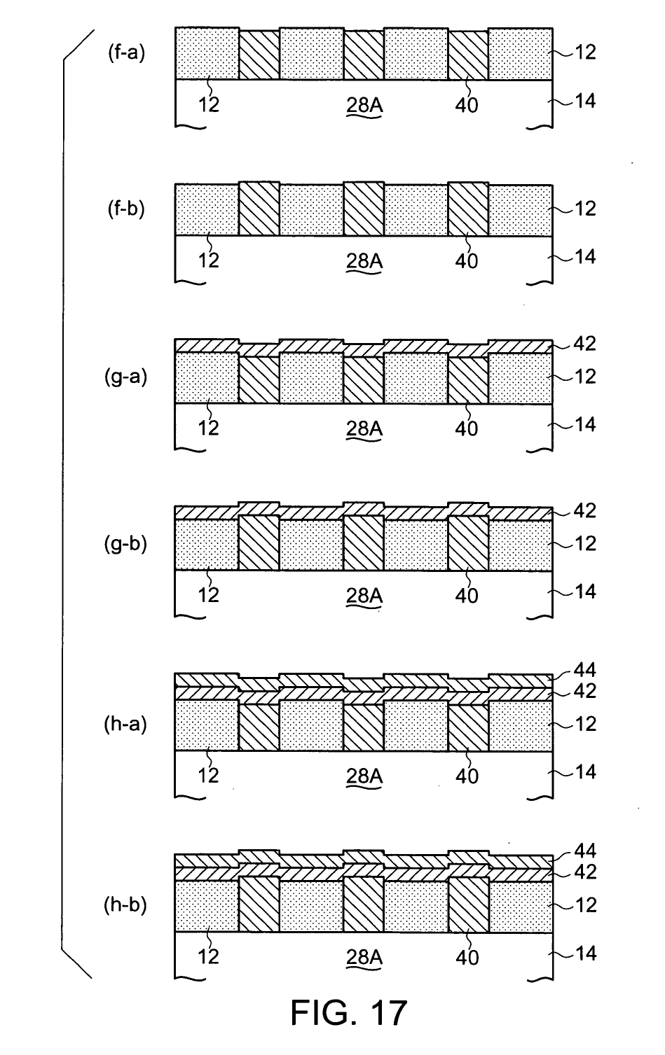

The steps illustrated in (e) to (g) in FIG. 16 in the modification to the third method embodiment are described far more in detail with reference to FIG. 17.

The etching step in (e) in FIG. 16 to remove the cover layer 51 corresponds to a step illustrated in (f-a) or (f-b) in FIG. 17 for an RIE etching and planarizing procedure to remove the cover layer 51 on the pixel electrodes 12.

Etching cannot be constant over the pixel electrodes 12, thus inevitably creating steps between the upper surfaces of the electrodes 12 and the insulating material 40, in other words, concave sections on the upper surfaces of the material 40 with respect to those of the electrodes 12 as shown in (f-a) in FIG. 17 or convex sections on the material 40 to the electrodes 12 as shown in (f-b) in FIG. 17. These steps, however, exhibit a phase difference of 0.2 λ or smaller due to etching only to the cover layer 51 and the electrodes 12 under this film, thus not restricting reflectivity enhancing effects.

After completion of the etching step, the first dielectric film 42 is formed with a lower-refraction-index material at a certain thickness by deposition, as shown in (g-a) or (g-b) in FIG. 17. Illustrated in (g-a) and (g-b) in FIG. 17 are the first dielectric film 42 formed with respect to the concave sections and the convex sections, respectively, created on the upper surfaces of the material 40 in the etching step.

Next, as shown in (h-a) or (h-b) in FIG. 17, the second dielectric film 44 is formed at a certain thickness by deposition with a material that exhibits a higher refraction index than the first dielectric film 42. Illustrated in (h-a) and (h-b) in FIG. 17 are the second dielectric film 44 formed with respect to the concave sections and the convex sections, respectively, created on the upper surfaces of the material 40 in the etching step discussed above.

Discussed next is evaluation of the embodiments and modifications disclosed above.

Sample liquid crystal display apparatuses were prepared as follows: Prepared first were sample driver substrates produced according to the embodiments and modifications. Also prepared were transparent glass substrates each having an ITO-electrode film thereon. An SiO₂-alignment film was formed on each sample driver substrate by oblique deposition. The same was true for each transparent substrate. The sample driver substrates and the corresponding transparent substrates were then attached to each other via spacers with liquid crystals filled therein, thus the sample liquid crystal display apparatuses being produced.

Also prepared was a comparative sample liquid crystal display apparatus having a driver substrate with reflectivity-enhancing films produced according to the known method discussed first.

The sample liquid crystal display apparatuses produced according to the embodiments and modifications are referred to as “samples” hereinafter. The comparative sample liquid crystal display apparatus is referred to as “comparative sample” hereinafter.

The samples and the comparative sample were evaluated on brightness by using a channel green in the optical system shown in FIG. 18.

All of the samples in the present invention exhibited brightness about 12% higher than the comparative sample with reflectivity-enhancing films. The comparative sample did not show almost no improvements in brightness although simulation suggested increase of about 8% in reflectivity with the help of reflectivity-enhancing films.

The following are several possible reasons behind the differences between the samples and the comparative sample.

Heights of the steps created between adjacent pixel electrodes were measured for the samples and the comparative sample. The height was 70 nm for the comparative sample. In contrast, it was 20 nm for the samples of the first method embodiment and the first modification to the third method embodiment. It was 20 nm or less with small undulation for the sample of the second method embodiment. It was also 20 nm or less with small undulation for the sample of the third method embodiment that exhibited brightness 1% lower than the sample of the first modification to the third method embodiment but 11% higher than the comparative sample. Undulation is a possible reason that the sample of the third method embodiment suffered decrease of 1% in brightness than the sample of the first modification to the third method embodiment.

A pixel electrode can be regarded as a diffraction grating. Therefore, the step height H2 shown in (d) in FIG. 7 is an important parameter in addition to pixel pitch. The step height H2 firmly exists no matter how dielectric films are formed thereon. Diffraction strength is minimum at 2nd/λ=0, 1, 2, . . . whereas maximum at 2nd/λ=1/2, 3/2, . . . . A liquid crystal exhibits a refractive index in the range from 1.5 to 1.6 at d=H2 and λ=550 nm.

It is thought that these factors gave the comparative sample a phase difference of about 0.4 λ, and hence almost maximum diffraction strength which gave null reflection enhancing effects, resulting in no enhancement in brightness against the simulation.

On the contrary, 20 nm in step of the samples in the present invention corresponds to mere 0.11 λ in phase difference which gives a comparatively higher reflectivity, as shown in FIG. 2. Actually, every sample exhibited higher brightness more than expected.

A possible reason is that the comparative sample initially involved considerable loss due to the maximum diffraction strength discussed above whereas the samples in the present invention suffered a smaller loss due to diffraction strength.

Simulation suggested 12% in reflectivity on the gaps between adjacent pixels, which cannot be actually measured.

The second modification (FIG. 13) to the second method embodiment, with the silver alloy films formed on the aluminum alloy electrodes, exhibited enhancement in reflectivity by 15% with respect to the comparative sample. A modified comparative sample produced with silver alloy films formed on the electrodes of the comparative sample showed almost no improvements in reflectivity.

Described next is the mechanism of the optical system shown in FIG. 18 used for evaluation of the samples and comparative samples, discussed above.

An optical system 60 is a color separating and composing system equipped with a display apparatus. The system 60 constitutes a projector, together with a light source, a projection lens, driver circuitry, etc., (all not shown). The light source emits light composed of red-light component R, green-light component G and blue-light component B in three primary colors.

The optical system 60 is equipped with: a first polarizer 61 to rotate the polarization plane of the green-light component G of the emitted light by 90 degrees; a first polarization beam splitter 62 to allow the polarized green-light component G to pass therethrough but reflect the red-light and blue-light components R and B; and a second polarizer 63 to rotate the polarization plane of the reflected red-light component R by 90 degrees but allow the reflected blue-light component B to pass therethrough;

Moreover, the optical system 60 is equipped with: a reflective liquid crystal display device 64 to modulate the red-light component R polarized by the second polarizer 63; a reflective liquid crystal display device 65 to modulate the reflected blue-light component B; and a second polarization beam splitter 66 to allow the polarized red-light component R to pass therethrough but reflect the blue-light component B, both components being sent from the polarizer 63, reflect the red-light component R modulated by the device 64 but allow the blue-light component B modulated by the device 65 to pass therethrough.

Furthermore, the optical system 60 is equipped with: a reflective liquid crystal display device 68 to modulate the green-light component G that is polarized by the first polarizer 61 and passes through the first polarization beam splitter 62; and a third polarization beam splitter 67 to allow the green-light component G to pass therethrough to the device 68 and reflect the green-light component G modulated by the device 68.

Still furthermore, the optical system 60 is equipped with: a third polarizer 69 to rotate the polarization plane of the red-light component R by 90 degrees but allow the blue-light component B to pass therethrough, both components being sent from the second polarization beam splitter 66; a fourth polarization beam splitter 70 to allow the red- and blue-light components R and B sent from the polarizer 69 to pass therethrough but reflect the green-light component G reflected by the third polarization beam splitter 67; and a fourth polarizer 71 to rotate the polarization plane of the green-light component G by 90 degrees but allow the red- and blue-light components R and B to pass therethrough, the three components being sent from the splitter 70.

In operation, an S-polarized red-light component of the light emitted from the light source is allowed to pass through the first polarizer 61, reflected by the first polarization beam splitter 62 and converted into a P-polarized red-light component by the second polarizer 63. The P-polarized red-light component is allowed to pass through the second polarization beam splitter 66 and modulated into an S-polarized red-light component by the reflective liquid crystal display device 64. The S-polarized red-light component modulated by the display device 74 is reflected by the beam splitter 66 and converted into a P-polarized red-light component by the third polarizer 69. The P-polarized red-light component converted by the polarizer 69 is allowed to pass through the fourth polarization beam splitter 70 and also the fourth polarizer 71.

An S-polarized green-light component of the light emitted from the light source is converted into a P-polarized green-light component by the first polarizer 61. The P-polarized green-light component is allowed to pass through the first and third polarization beam splitters 62 and 67 and modulated into an S-polarized green-light component by the reflective liquid crystal display device 68. The S-polarized green-light component modulated by the display device 68 is reflected by the beam splitter 67 and further by the fourth polarization beam splitter 70, and converted into a P-polarized green-light component by the fourth polarizer 71.

An S-polarized blue-light component of the light emitted from the light source is allowed to pass through the first polarizer 61, reflected by the first polarization beam splitter 62, allowed to pass through the second polarizer 63, reflected by the second polarization beam splitter 66, and converted into a P-polarized blue-light component by the reflective liquid crystal display device 65. The P-polarized blue-light component is allowed to pass through the beam splitter 66, the third polarizer 69, the fourth polarization beam splitter 70 and the fourth polarizer 71.

The P-polarized red-, green- and blue-light components (the output of the fourth polarizer 71) are projected onto a screen via the projection lens (not shown).

The light source (not shown) is preferably an ultrahigh pressure mercury lamp that exhibits high luminous efficiency.

The reflective optical system 60 has a series connection of the polarization beam splitters and the color composing optical components, as shown in FIG. 18, thus suffering from a longer optical length and hence a larger F value.

The structure having a larger F value cannot provide all diffracted lights generated on the reflective liquid crystal display devices to the projection lens, the remainings being lost. This is the loss due to diffraction, discussed above. A reflective optical system having a larger F value suffers considerably larger loss. It is thus very important to suppress diffracted lights for higher brightness.

However, the samples in the present invention having the reflectivity enhancing films (the dielectric films 42 and 44) that exhibited 20 nm in step height between adjacent pixel electrodes suffered almost no increase in diffraction when installed in the optical system 60 shown in FIG. 18. This is consistent with the simulated results. The effects can be expected when the phase difference due to steps is 0.2 λ or smaller.

The advantages of the present invention discussed above can be gained not only with the dual-layer reflectivity enhancing films in the embodiments and modifications but also quartet-layer reflectivity enhancing films or more.

The embodiments and modifications of the present invention employ SOG or a silicon oxide film for the first dielectric film 42. Alternatives to these materials are MgF₂, Al₂O₃, etc. Moreover, the embodiments and modifications employ a tantalum oxide film for the second dielectric film 44. Alternatives to this material are a silicon nitride film or a metal oxide film involving ZrO₂, TiO₂, Nb₂O₅, Ta₂O₅, etc.

The thickness of the silver alloy thin film used for the pixel electrodes in the embodiments and modifications can take not only 30 nm, as disclosed above, but also any value in the range from about 20 to 50 nm. In addition, the pixel electrodes may be made of silver alloy only.

The material of the cover layer 51 is not only TiN used in the modification to the third method embodiment but also other types of metal materials, such as Ti or an alloy of Ti. One requirement for this material is that it exhibits a lower etching rate in etching an insulating film such as SiO₂, but a higher etching rate in etching the cover layer 51 than an insulating film and a conductive film for pixel electrodes.

As disclosed above in detail, the reflective liquid crystal display apparatus and the method of producing the liquid crystal display apparatus according to the present invention have the following advantages:

In the present invention, the first dielectric film is formed as planar over the pixel electrodes and the gaps between adjacent pixel electrodes. The second dielectric film is then formed on the first film. The second film exhibits a higher refractive index than the first film. Both films are adjusted to the thickness of at about λ/4 (λ: a wavelength to be used).

This structure having the planar surface over the pixel electrodes with almost no steps between adjacent electrodes can be achieved without installation of an advanced microfabrication equipment and precisely controlled processing, thus offering higher reflectivity enhancing effects with the help of the lower-refraction-index dielectric film and the higher-refraction-index dielectric film. A more higher reflectivity can be gained by use of a silver-contained film for the pixel electrodes.

Accordingly, the present invention achieves easier formation of the reflectivity enhancing films in the area including the pixel electrodes, thus offering high yields in production of liquid crystal display apparatuses with smaller loss due to diffraction at low cost.

What is claimed is:

1. A liquid crystal display apparatus comprising:
a driver substrate having a pixel area with pixel electrodes and drive circuits each driving the corresponding pixel electrode arranged in a matrix in the pixel area, an dielectric material being provided in a gap between each pair of two adjacent pixel electrodes, with 0.2 λ or lower (λ being a wavelength of reading light to be used) in phase difference of a step created on the dielectric material provided in the gap with respect to each pixel electrode, a first dielectric film and a second dielectric film being laminated in order in the pixel area, the second dielectric film exhibiting a higher refractive index than the first dielectric film; and
a transparent substrate having an opposing electrode, the driver substrate and the transparent substrate facing each other with a liquid crystal filled between the pixel electrodes and the opposing electrode.

2. The liquid crystal display apparatus according to claim 1, wherein the first and second dielectric films have a thickness of about λ/4.

3. A liquid crystal display apparatus comprising:
a driver substrate having pixel electrodes and drive circuits each driving the corresponding pixel electrode arranged in a matrix, a first dielectric film of an dielectric material being provided over the pixel electrodes and in a gap between each pair of two adjacent pixel electrodes, with 0.2 λ or lower (λ being a wavelength of reading light to be used) in phase difference of a step created on the dielectric material provided in the gap with respect to each pixel electrode, a second dielectric film being formed on the first dielectric film, the second dielectric film exhibiting a higher refractive index than the first dielectric film; and
a transparent substrate having an opposing electrode, the driver substrate and the transparent substrate facing each other with a liquid crystal filled between the pixel electrodes and the opposing electrode.

4. The liquid crystal display apparatus according to claim 3, wherein each pixel electrode is made of an aluminum-alloy electrode coated with a silver-alloy film having a thickness in the range from 20 nm to 50 nm.

5. The liquid crystal display apparatus according to claim 3, wherein the first and second dielectric films have a thickness of about λ/4.

6. A method of producing a liquid crystal display apparatus including a driver substrate having pixel electrodes and drive circuits each driving the corresponding pixel electrode arranged in a matrix and a transparent substrate having an opposing electrode, the driver substrate and the transparent substrate facing each other with a liquid crystal filled between the pixel electrodes and the opposing electrode, the method comprising the steps of:
forming a dielectric layer of a dielectric material over the pixel electrodes while filling the dielectric material into a gap between each pair of two adjacent pixel electrodes, with 0.2 λ or lower (λ being a wavelength of reading light to be used) in phase difference of a step created on the dielectric material provided in the gap with respect to each pixel electrode;
planarizing a surface of the dielectric layer;
etching the planarized dielectric layer until at least the pixel electrodes are exposed at an almost same etching rate to the planarized dielectric layer and the pixel electrodes;
forming a first dielectric film over the etched dielectric layer and pixel electrodes; and
forming a second dielectric film on the first dielectric film, the second dielectric film exhibiting a higher refractive index than the first dielectric film.

7. A method of producing a liquid crystal display apparatus including a driver substrate having pixel electrodes and drive circuits each driving the corresponding pixel electrode arranged in a matrix and a transparent substrate having an opposing electrode, the driver substrate and the transparent substrate facing each other with a liquid crystal filled between the pixel electrodes and the opposing electrode, the method comprising the steps of:
forming a dielectric layer of a dielectric material over the pixel electrodes while filling the dielectric material into a gap between each pair of two adjacent pixel electrodes, with 0.2 λ or lower (λ being a wavelength of reading light to be used) in phase difference of a step created on the dielectric material provided in the gap with respect to each pixel electrode;
planarizing a surface of the dielectric layer so that the dielectric layer is turned into a first dielectric film; and
forming a second dielectric film on the first dielectric film, the second dielectric film exhibiting a higher refractive index than the first dielectric film.

8. A method of producing a liquid crystal display apparatus including a driver substrate having pixel electrodes and drive circuits each driving the corresponding pixel electrode arranged in a matrix and a transparent substrate having an opposing electrode, the driver substrate and the transparent substrate facing each other with a liquid crystal filled between the pixel electrodes and the opposing electrode, the method comprising the steps of:
forming a dielectric layer of a dielectric material over the pixel electrodes while filling the dielectric material into a gap between each pair of two adjacent pixel electrodes, with 0.2 λ or lower (λ being a wavelength of reading light to be used) in phase difference of a step created on the dielectric material provided in the gap with respect to each pixel electrode;
planarizing a surface of the dielectric layer;
etching the planarized dielectric layer until at least the pixel electrodes are exposed;
etching the exposed pixel electrodes only;
forming a first dielectric film over the etched dielectric layer and pixel electrodes; and
forming a second dielectric film on the first dielectric film, the second dielectric film exhibiting a higher refractive index than the first dielectric film.

9. A method of producing a liquid crystal display apparatus including a driver substrate having pixel electrodes and drive circuits each driving the corresponding pixel electrode arranged in a matrix and a transparent substrate having an opposing electrode, the driver substrate and the transparent substrate facing each other with a liquid crystal filled between the pixel electrodes and the opposing electrode, the method comprising the steps of:
forming a cover layer on the pixel electrodes;
forming a dielectric layer of a dielectric material over the pixel electrodes via the cover layer while filling the dielectric material into a gap between each pair of two adjacent pixel electrodes, with 0.2 λ or lower (λ being a wavelength of reading light to be used) in phase difference of a step created on the dielectric material provided in the gap with respect to each pixel electrode;
planarizing a surface of the dielectric layer;
etching the dielectric layer until the cover layer is exposed;
etching the exposed cover layer only to expose the pixel electrodes;
forming a first dielectric film over the etched dielectric layer and the exposed pixel electrodes; and
forming a second dielectric film on the first dielectric film, the second dielectric film exhibiting a higher refractive index than the first dielectric film.
